(19) United States
(12) Patent Application Publication
(10) Pub. No.: US 2022/0051647 A1
(43) Pub. Date: Feb. 17, 2022

(54) Musical Instrument Interface Device

(71) Applicant: Sonoclast, LLC, Durham, NC (US)

(72) Inventor: Kevin Chang, Durham, NC (US)

(73) Assignee: Sonoclast, LLC, Durham, NC (US)

(21) Appl. No.: 17/513,858

(22) Filed: Oct. 28, 2021

Related U.S. Application Data
(63) Continuation-in-part of application No. 16/997,220, filed on Aug. 19, 2020.
(60) Provisional application No. 62/889,933, filed on Aug. 21, 2019.

(51) Int. Cl. G10H 1/00; G06F 3/16; G10H 1/14

(52) U.S. Cl. CPC G10H 1/0066; G06F 3/162; G10H 1/14; G10H 2220/265; G10H 2240/311; G10H 2210/155; G10H 2240/285

(57) ABSTRACT

A musical device between one or more Musical Instrument Digital Interface (MIDI) controllers and one or more musical instruments comprises a housing and a plurality of potentiometers on a surface of the housing. A method of mapping music messages using a musical device is provided. The method includes defining a preset value corresponding to a frequency to be received within a MIDI message. Once a MIDI message having the frequency is received by the device, the device uses the data of the MIDI message and the preset value to create a new output MIDI message. The new output message is then transmitted to a sound module for producing a sound that differs from the sound that would have been produced from the MIDI message, had it been received.

### CROSS REFERENCE TO RELATED APPLICATIONS

This application is a continuation-in-part of U.S. patent application Ser. No. 16/997,220 filed on Aug. 19, 2020, which claims the benefit of U.S. Provisional Patent Application No. 62/889,933, filed on Aug. 21, 2019, the contents of which is incorporated herein by reference in their entirety. This application also claims the benefit of U.S. Provisional Patent Application No. 63/206,384 filed Oct. 28, 2020, the contents of which is incorporated herein by reference in its entirety.

### TECHNICAL FIELD

The present disclosure relates generally to an electronic music device for creating music. More specifically, the present disclosure relates to methods of using the electronic music device to alter received MIDI messages.

### BACKGROUND

Microtonal music, or microtonality, pertains to the use in music using notes or the like that fall between the twelve equally-sized intervals of a musical octave.

Conventional methods of experimenting with microtuning electronic musical instruments or the like involve loading a specific tuning, often in the form of a list of frequencies or frequency ratios, and then playing the tuning to hear how it sounds. However, there are limitations with the conventional methods.

When performing conventional tuning methods, the relationship between one tuning and another can be understood numerically and by listening to the difference, which may be large, while toggling between two tuning presets. However, it is more natural for a musician to experience said relationship by listening to the process of retuning without large jumps in tuning and mediated through an interface that correlates retuning with meaningful movements of one's body.

Conventional tuning methods favor viewing tuning as somewhat immutable and are not suited for tuning in real-time, for example, while performing a musical piece. A piano, for instance, may be tuned by a skilled technician ahead of a performance and are difficult to retune while performing the musical piece. However, electronic musical instruments are not inherently constrained in that way, and it can be musically advantageous to be able to retune an instrument in real-time.

Conventional methods of tuning favor viewing tuning as something that are imposed on an instrument and not something that can be renegotiated. The spectral content of a timbre produced correlates to the scale tunings that are commonly considered musical for that timbre. For instance, the common scale composed of 12 equally-sized intervals of an octave roughly correlate to the harmonic series, and harmonic timbres (i.e., ones composed of the harmonic series) are the most common timbres. In contrast, electronic musical instruments allow a musician to explore unconventional and sometimes inharmonic timbres. To find a suitable scale tuning for an inharmonic timbre, conventional tuning methods require a rationalistic approach of measuring the spectral content of the timbre and doing mathematical calculations to generate a list of possible frequencies or frequency ratios, all before getting to hear the tuning. However, it may be more natural for a musician to approach tuning empirically by using an ear to find a suitable scale tuning for a newly discovered timbre.

Further, Musical Instrument Digital Interface (MIDI) controllers and synthesizers are diverse and ubiquitous in the music industry, and amongst casual musicians. A musician interacts with an interface of the MIDI controller, which in turn transmits MIDI messages corresponding to the interactions for producing musical sound. Typically, prior art synthesizers of MIDI messages merely translate the messages or notes played into a corresponding frequency or pitch, duration, and velocity (how hard the note was played). Musicians may desire the ability to further customize the synthetization of the MIDI messages, allowing for more creative expression. Disclosed herein are one or more devices and methods that advantageously permit musicians to individually customize each MIDI message.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a method of mapping music messages is provided. The method includes: defining a preset value corresponding to a frequency; receiving a MIDI message from a MIDI controller, wherein the MIDI message includes the frequency; modifying the MIDI message by replacing the frequency with the preset value; and transmitting the preset message to a sound device for producing sound.

In another embodiment, a musical device between MIDI controllers and one or more musical instruments is provided. The device includes: a housing; a plurality of potentiometers on a surface of the housing, the potentiometers comprising: twelve tuning potentiometers constructed and arranged to correspond to notes of a musical scale, each tuning knob for tuning one of the notes; an offset potentiometer for globally tuning all of the notes by a same amount; and a range potentiometer for setting a maximum tuning range of the tuning potentiometers; and a microprocessor in the housing that modifies a MIDI data stream received from one or more MIDI controllers for output to one or more musical instruments according to a position of the potentiometers.

In another embodiment, the device includes: a special-purpose microprocessor that modifies a MIDI data stream received from one or more MIDI controllers for output to one or more musical instruments and a musical device, wherein when a MIDI message comprising a note may be received on a pre-configured MIDI channel or dedicated hardware input port, the microprocessor replaces the reference note with the received MIDI note and recalculates the tuning array relative to it; and a memory device that stores computer program code, a tuning array or other suitable data structure, and a reference note or frequency, wherein the tuning array comprises numerical tuning values relative to the reference note or frequency and for each and every note to be retuned, wherein the tuning array may be used for calculations to generate tuned MIDI output, wherein when a MIDI message comprising a note may be received on the pre-configured MIDI channel or dedicated hardware input port, the microprocessor replaces the reference note with the tuned note resulting from the received MIDI note and recalculates the tuning array relative to it.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated, in which like references indicate similar elements. The present invention is illustrated by way of example. Elements in the figures are illustrated for simplicity and clarity and have not necessarily been drawn to scale.

FIG. 1 is a block diagram of a musical device interfacing a Musical Instrument Digital Interface (MIDI) controller and a musical instrument, in accordance with some embodiments of the inventive concepts.

FIG. 1A is a block diagram of a musical device interfacing a plurality of Musical Instrument Digital Interface (MIDI) controllers and a plurality of musical instruments, in accordance with some embodiments of the inventive concepts.

FIG. 2 is a front view of a musical device, in accordance with some embodiments of the inventive concepts.

FIG. 3 is a top view of the musical device of FIG. 2.

FIG. 4 is a block diagram of the musical device of FIGS. 1-3, in accordance with some embodiments of the inventive concepts.

FIG. 5 is a front view of a musical device, in accordance with other embodiments of the inventive concepts.

FIG. 6 is a flow diagram of a method of operation of a musical device, in accordance with some embodiments of the inventive concepts.

FIG. 6A is a flow diagram of a method of operation of a musical device, in accordance with some embodiments of the inventive concepts.

FIG. 7 is a flow diagram of a method for selecting a fundamental algorithm for processing MIDI messages, in accordance with some embodiments of the inventive concepts.

FIG. 8 is a flow diagram of a method for selecting an output port to output MIDI messages, in accordance with some embodiments of the inventive concepts.

FIG. 9 is a front view of a musical device, in accordance with other embodiments of the inventive concepts.

FIG. 10 is a depiction of some elements of a MIDI message, in accordance with embodiments of the inventive concepts.

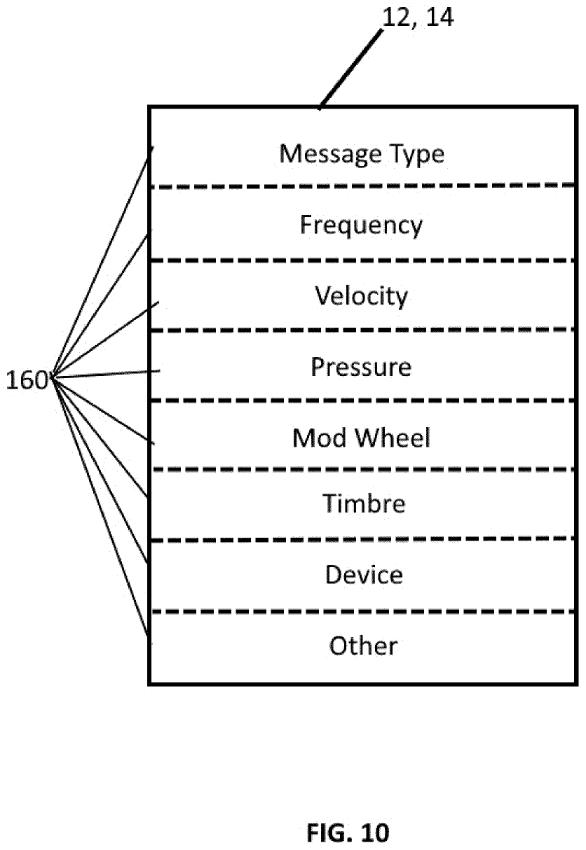

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment are made according to the apparent relative scale of the drawing.

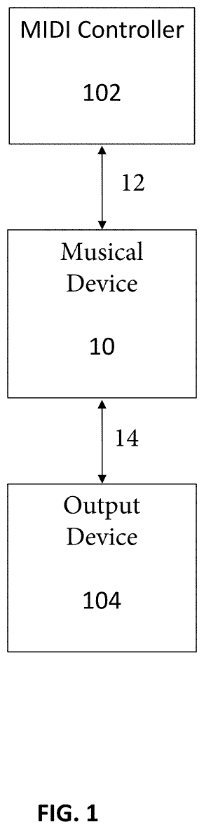

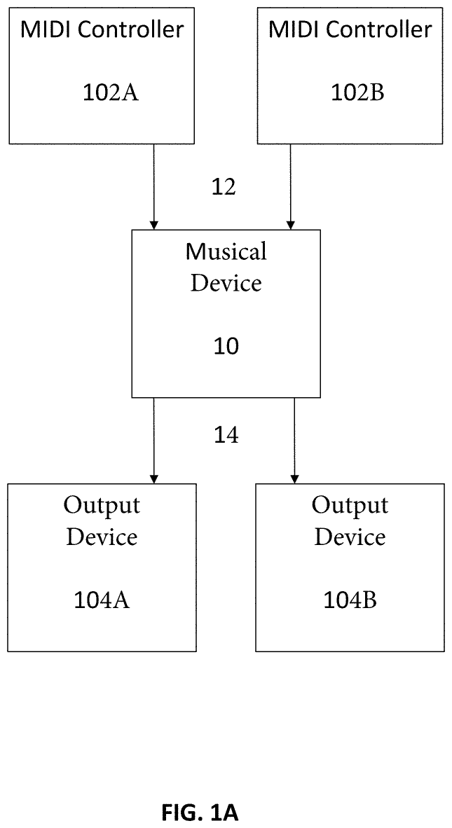

In brief overview, a MIDI musical device 10 is described which may receive one or more input MIDI messages 12 from a MIDI controller 102 of, for example, a digital musical instrument, for allowing a user to perform various tunings or adjustments to the input MIDI messages 12, according to any one of the multiple ways offered by the MIDI standard, and then sending one or more output MIDI messages 14 to a musical MIDI output device 104. As shown in FIG. 1, in some embodiments, tunings or adjustments to input MIDI messages may be accomplished by a musical instrument musical device 10 modifying a data stream of input MIDI messages 12, also referred to as “tuned MIDI data”, received from a MIDI controller 102 for output to an output device 104. Accordingly, the musical device 10 may provide an intuitive way to perform and/or experiment with microtonal or other experimental MIDI message adjustments on the MIDI controller 102.

Example MIDI controllers 102 may include but not be limited to performance controllers such as keyboards, electric guitars, drum and percussion instruments, wind controllers, or other specialized controllers, and may further include auxiliary controllers such as control surfaces or other real-time controllers. Example MIDI output devices 104 may include but not be limited to speakers, sound modules, synthesizers, computing devices or other musical outputs or processing devices. The musical device 10 may receive or send MIDI messages 12, 14 using any combination of transmission methods available in the prior art, including but not limited to using a MIDI or USB cable, wireless transmissions, DIN inputs or outputs, or other methods. Typically, a MIDI controller 102 has some type of interface, which a musician presses, strikes, blows, touches and/or interacts with in some other fashion. Typically, the interaction with the MIDI interface generates one or more MIDI messages that are transmitted to a MIDI-compatible sound module or synthesizer. In the present invention, a device 10 may receive the generated MIDI messages as input MIDI messages 12 for manipulation before sending output MIDI messages 14 along to a compatible sound module or synthesizer or other device (which may or may not include or further transmit the messages 14 to a loudspeaker).

Though there are a number of types of input MIDI messages 12 available using one of the MIDI standard message format, two key types are the channel voice messages for “note on” and “note off”, which may include data referencing the message's channel, frequency and velocity (each being MIDI message elements 160). In some embodiments, a MIDI controller 102 may include one of one-hundred and twenty-eight different frequencies in each MIDI message 12. In some embodiments, an output device 104 may receive the MIDI messages 14 and the timbral difference between the sounds produced by two difference frequencies having the same velocity and originating from the same MIDI controller 102 may be related to the pitch. A low frequency received by the output device 104 may generate a sound with a lower pitch, and high frequency may generate a sound with a higher pitch (i.e., each sound may appear to originate from the same piano, but at different pitches—every timbre triggered to sound is commonly recognized as relatively homogeneous across the whole controller 102). The present invention allows the timbre to remain homogeneous, while manipulating the frequency, pitch or other quality, or, alternatively, for diverse and heterogeneous timbres to be triggered across a whole MIDI controller 102.

As used herein, the term “frequency” refers to the fundamental frequency, or musical pitch or lowest partial present, of the note being represented by a MIDI message 12, 14. In addition to the channel, frequency and velocity, a MIDI message 12, 14 may also contain the message elements 160 of a pressure and/or a mod wheel value, or even a timbre or device identifier corresponding the model or type of MIDI controller creating the MIDI input message 12. The “velocity” may correspond to how hard a key is struck. In some embodiments, the value of the velocity may range from 0-127 and may correspond to a voltage level from 0V to 5V. The pressure may correspond to how hard a key is pressed after being struck. In some embodiments, the value of the pressure 26 may range from 0-127 and may correspond to a voltage level from 0V to 5V. The mod wheel 28 may correspond to the position of one or more controls positioned on the MIDI controller 102. In some embodiments, the value of the mod wheel 28 may range from 0-127 and may correspond to a voltage level from 0V to 5V.

As shown in FIG. 1A, in some embodiments, tuning and adjustments to elements 160 of input MIDI messages 12 may be accomplished by an interface device 10 modifying a data stream of one or more input MIDI messages 12 received from a single or a plurality of MIDI controllers 102 for output of one or more output MIDI messages 14 to a single or a plurality of MIDI output devices 104. Accordingly, the musical device 10 addresses and overcomes deficiencies of the conventional tuning and experimental adjustment techniques described above. For example, a user can more easily use their ears to develop a sense of the relationship between different tunings and adjustments and their hands to feel the tuning process of moving potentiometers 112. A user can change tuning and/or adjustments in real-time as part of a performance, for example, during a free jazz performance. Another example may be too quickly change keys for an intonation tuning which may be commonly regarded as sounding best in only one key. A user can intuitively use their ears while turning tuning knobs to empirically find a suitable tuning and/or adjustment during and/or after modifying the timbre produced by the instrument.

In some embodiments, the device 10 may map keys and microtonal pitches to provide immediate and independent control of pitches in a scale. In contrast to executing microtonality by generating lists of frequencies or ratios, embodiments of the inventive musical device may naturally engage the ear of a listener and provide an intuitive way to experiment with microtonal pitches. In other embodiments, the device 10 may be configured for permitting a user to define one or more preset values corresponding to each of the elements 160 (e.g., frequency) capable of being included in an input MIDI message 12, so that the preset value may be applied to the input MIDI message 12 to create a preset output MIDI message 14. In some examples, the preset value may be a new frequency, or an amplitude, or a noise distortion, light effect, or a different instrumental timber (e.g., upon receipt of a first frequency, the device 10 may cause a piano sound to be played, but the subsequent receipt of a second frequency, from the same controller 102, the device 10 may cause a trumpet sound to be played).

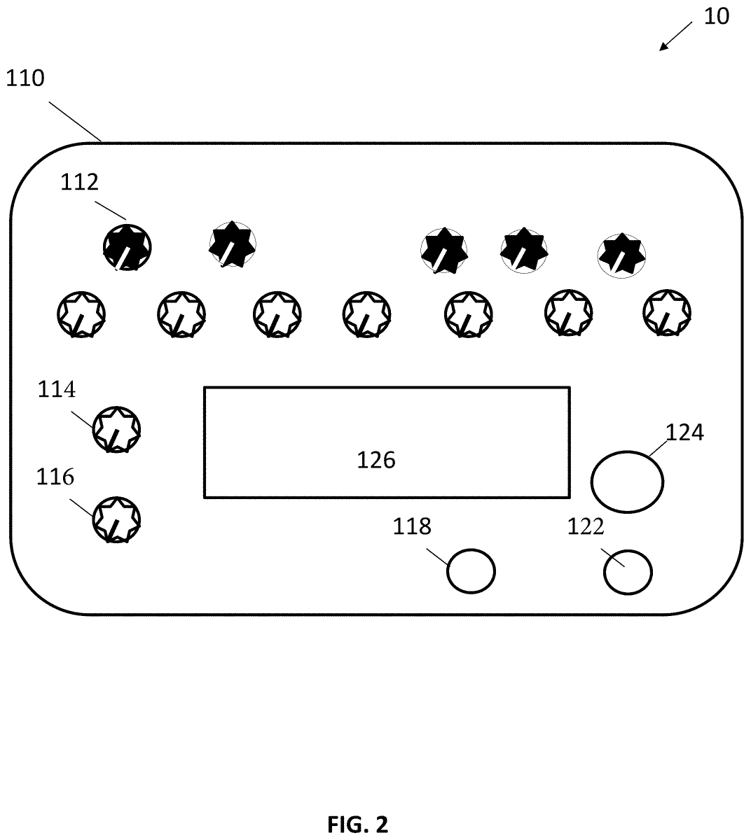

FIG. 2 is a front view of a musical device 10 in accordance with some embodiments of the inventive concepts. As described in FIG. 1, the musical device 10 may be constructed and arranged to be connected between a combination of one or more MIDI controllers 102 and/or one or more musical output devices 104. According to some embodiments, the musical interface device 10 may be constructed and arranged to operate in various modes, such as a twelve-tone tuning (12T) mode or an Equal Divisions per Octave (EDO) mode, also referred to as a Scala Preset mode. In the Scala Preset mode, the preset files and/or settings may specify tuning details such as parameters or other information according to a Scala file format and may be saved in memory 152, such as a micro-SD card or other memory device. In this mode, the display 126, rotary encoder 124, and buttons 118, 122 may be used to browse and load preset tunings. The presets may be saved by a user from the twelve-tone tuning mode, or generated in another manner, for example, downloaded from the Internet.

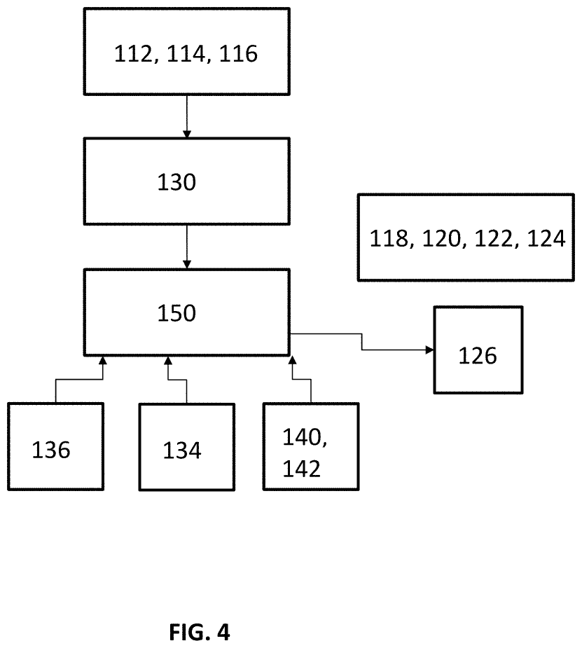

In some embodiments, the musical interface device 10 may include a set of tuning potentiometers 112 that operate to tune or adjust values and may be positioned on a housing 110 or other enclosure. In some embodiments, the potentiometers 112, 114, 116 may be linear taper potentiometers, slide potentiometers, rotary potentiometers such as knobs, and/or membrane potentiometers. The potentiometers 112 may be coupled to electrical circuitry (described herein) including a microprocessor 150 and analog-to-digital converter (ADC) 130 shown in FIG. 4 positioned inside the housing 110. In some embodiments, each potentiometer 112 may correspond to a note of a twelve-tone scale. In some embodiments, the potentiometers 112 may be arranged and color-coordinated to match a conventional piano keyboard layout, e.g., C, C♯/Db, D, D♯/Eb, E, F, F♯/Gb, G, G♯/Ab, A, A♯/Bb, and B keys. For example, the leftmost white knob may tune a C note of a white piano key, the leftmost black knob may tune a C-sharp note of a black piano key, and so on. So, for instance, the C knob may tune every C across every octave. Accordingly, in such an example, the potentiometers 112 may correspond to the notes of a twelve-tone musical scale, e.g., a chromatic scale, across the whole range of MIDI notes (0-127) for every note in the chromatic scale. The tuning may be neutral when the potentiometers are at 50%. In an embodiment where the potentiometer 112 is a knob, turning the knob left may tune flat and turning right may tune sharp. Other embodiments may include various physical arrangements and layouts of the potentiometers 112 depending on the instrument to which the interface device 10 communicates. In contrast to the twelve-tone tuning mode, conventional methods approach microtuning differently and provide a much less intuitive albeit common way of achieving microtonal scales that involves typing ratios and/or cent values into a text document.

The musical interface device 10 may also include a global tuning offset potentiometer 114 on the housing 110, which may be configured for tuning all notes, e.g., globally tuning the twelve notes controlled by the tuning potentiometers 112 by a same amount, such as a flat or sharp. For example, turning an offset knob 114 in a counterclockwise direction may provide a flat offset, and turning the offset 114 in a clockwise direction may provide a sharp offset. The tuning and global offset potentiometers 112, 114 may have a wide neutral zone implemented in the firmware of the apparatus. In some embodiments, experimental data indicates that 6% of the middle readings would be mapped to the neutral zone. Here, the lowest 47% of the readings are in a flat tuning zone and the highest 47% of the readings are in the sharp tuning zone. The remaining 6% of the readings may be interpreted as a neutral reading.

The musical interface device 10 may also include a range potentiometer 116 on the housing 110. The range potentiometer 116 may be constructed and arranged to set a maximum tuning range of the twelve tuning potentiometers 112. The range potentiometer 116 may permit adjusting a range of the tuning potentiometers 112 from 0% to 100%, where 0% refers to a neutral tuning parameter and 100% refers to the tuning potentiometers 112 spanning an entire preconfigured range. A combination of the global tuning offset potentiometer 114 and range potentiometer 116 may provide global control of the range of the tuning potentiometers 112, which may control the range of all of the tuning potentiometers 112. When the range potentiometer 116 is at 100%, the twelve tuning potentiometers 112 may operate at full range giving the widest range of tuning from the flattest to sharpest. When the range potentiometer 116 is at 0%, the twelve tuning potentiometers 112 may be essentially disabled so that the musical interface device 10 simply passes the input MIDI message(s) 12 thru as output MIDI message(s) 14 without adjustment. This may be a great feature for performers wanting to quickly revert to the standard twelve-tone tuning. The range potentiometer 116 may be anywhere between 0 and 100%, and then the twelve tuning potentiometers 112 will have less than the full range available.

The musical interface device 10 may also include a set of buttons 117, for example, a “Back” button 118 and “Enter” button 122, for navigating a configuration menu displayed on a display 126. In some embodiments, the display 126 may be a liquid crystal display (LCD), for example, a forty×four character LCD, another display disclosed by the prior art, or any other display developed. In some embodiments, the display 126 may display up to one hundred and sixty alpha-numeric characters across four rows. The display 126 may display the tuning results corresponding to musical intervals, expressed in relative cents or the like, provided by the tuning potentiometers 112 and/or other tuning information in real-time or near real-time, which may be helpful for repeating tunings or matching the tuning of other instruments. In some embodiments, the tuning potentiometers 112 may be configured to span+/−one hundred cents, whereby the range of rotation can span one hundred cents flat or one hundred cents sharp. In the middle position, a potentiometer 112 may be in a neutral tuning position, and spans a larger range of the potentiometer's physical rotation than each of the other one hundred and ninety-nine steps of the range. In some embodiments, the display 126 displays a configuration menu for configuring the absolute ranges of the global offset 114 and tuning potentiometers 112 with note names.

In some embodiments, the musical interface device 10 also includes a rotary encoder 124 on the housing 110 that can set a pitch bend range used in calculating the cents to display for a 12T (non-EDO) mode. In some embodiments, the pitch bend range may be set within a configuration menu, described below. In some embodiments, the rotary encoder 124 may be a knob that provides twenty-four detents per revolution but not limited thereto. The rotary encoder 124 can be turned, or otherwise set, to match the pitch bend range of the MIDI instruments 102, 104 to which the interface device 10 may be attached. The rotary encoder 124 allows setting the pitch bend range used in calculating the cents to display for the 12T mode. It may be set to match the pitch bend range of the MIDI output device 104 and/or MIDI input device 102. The buttons 117 and rotary encoder 124 may be used to navigate the display 126 through a configuration menu displayed at the display 126. For example, the buttons 117 may be used to navigate forward and backward through the menu and the rotary encoder 124 may be used to cycle through possible values of a selected menu item.

The following is an embodiment of a configuration and display tree that may be executed by a combination of the rotary encoder 124 and buttons 118, 122, a result of which may be displayed at the display 126 of FIG. 2.

A root display may display on the display 126 the current selected live mode, either twelve-tone or Scala Preset. The twelve-tone mode may display the relative tuning of each note to the nearest cent, also the global tuning amount to the nearest cent and the range to the nearest cent. These tuning values may be set with the corresponding potentiometers 112, 114, 116.

The Scala Preset mode may display the currently loaded Scala tuning file with the current reference MIDI note and any text such as a description included in the comment field of the Scala file.

For the root display, the Enter button 122 may change the display 126 to show the first level of a menu tree that includes various settings and utilities. The Back button 118 and rotary encoder 124 may not participate in this configuration until the menu tree is displayed.

For displays other than the root display, the Enter button 122 may save the selected value and updates the display 126 to display the next display as designated by the menu tree. The Back button 118 may cancel changing the selected value and updates the display 126 to the previous display. The rotary encoder 124 may decrement or increment the selected value.

The first level of the menu tree may include one or more of the following selectable options: Select Operating Mode, Save Tuning as a Scala Preset, Browse Scala Presets, Send MIDI Program Change Messages, Configure DIN1 MIDI Output, Configure DIN2 MIDI Output, Configure USB Device MIDI Output, Configure USB Host MIDI Output, and Global Settings and Utilities.

When a displayed option “Select Operating Mode” is selected, the user may be prompted to select between the twelve-tone tuning mode and the Scala preset mode. Selecting one of those modes results in the display 126 displaying the corresponding root display.

The display “Save Tuning as a Scala Preset” may be only available in the menu when in a twelve-tone tuning mode. When it is selected, the user may be prompted to select and enter a name for the Scala preset file as well as the reference note (C, C♯/Db, D, . . . , B) for the tuning operation. After that, a Scala file may be generated using the tuning values specified in twelve tone tuning mode with the tuning potentiometers 112 and range potentiometer 116 and then saved on memory 152 (e.g., via the memory card port 136 when the memory 152 is a micro-SD card). The display 126 may be updated to the root display of the twelve-tone tuning mode.

The “Browse Scala Presets” display may be only available in the menu when in Scala Preset mode. When it is selected, the user may be shown a file browser to select a tuning from the Scala files that may be saved on the memory 152. After selecting a file, the user may be prompted to enter the MIDI reference note (0-127 and corresponding note names per the MIDI specification), and then the tuning may be loaded for use with the MIDI tuning algorithms. The display 126 may be updated to the root display of the Scala preset mode.

When the display “Send MIDI Program Changes Mode” may be selected, the user may be prompted to enter the values specified for a MIDI program change messages: the MSB or Most Significant Byte (0-127), the LSB or Least Significant Byte (0-127), and the Program number (0-127). Then the user may be prompted to enter the MIDI output port to use DIN1 142, DIN2 144, USB device 134, USB host 138). After that, a MIDI program change message may be generated for every configured channel on the specified port and sent out the port. The display 126 may be updated to display the first level of the menu tree.

When one of the following displays “Configure DIN1 MIDI Output,” “Configure DIN2 MIDI Output,” “Configure USB Device MIDI Output,” or “Configure USB Host MIDI Output” may be selected, the user may be prompted to select the following settings specific to the respective output port. The input MIDI channel (0-15 or OFF) may be the channel a controller sends MIDI to be processed by the designated MIDI tuning algorithm. “OFF” means that no MIDI messages will be processed for the respective output port. The output MIDI channel (0-15) may be the base MIDI channel used to send the tuned MIDI messages. The MIDI mode (pitch bend or MIDI tuning standard) selects which method to use to perform the tuning. If “pitch bend” may be selected, then the user may be prompted in enter the number of MIDI channels to use (1-16), and, for one MIDI channel, which monophonic re-trigger mode to use (low note, high note, or last note). If “MIDI tuning standard” may be selected, the user may be prompted to select the format (scale per octave real-time, scale per octave non-real-time, single note real-time without a bank, single note real-time, and single note non-real-time) and the bank (0-127) if applicable. After those selections may be made, the configuration may be saved on memory 152 so that the configuration may be available again after powering off and back on. The settings may be also used to choose the designated MIDI tuning algorithms that may be used. The display 126 may be updated to display the first level of the menu tree.

When the display “Global Settings and Utilities” may be selected, the following options may be selectable by the user: Pitch Bend Range, Global Offset Pitch Bend Range, Pitch Bend Tuning Mode, Absolute Retuning MIDI Channel, Relative Retuning MIDI Channel, Pot Calibration, and Mount the Micro SD Card. Whenever one of the global settings may be updated, the value may be stored on memory 152 to preserve the setting after powering off and on again.

When the display “Pitch Bend Range” may be selected, the user may be prompted to enter a whole number of semitones (1-12) that corresponds to the range of each of the twelve tuning potentiometers 112, where entering 1 means+/−1 semitone or +/−100 cents, 2 means+/−2 semitones or +/−200 cents, etc. When “Global Offset Pitch Bend Range” may be selected, the user may be similarly prompted to enter a whole number of semitones (1-12) that correspond to the range of the Global Offset potentiometer 114. When either of the two above pitch bend range values may be updated, a MIDI pitch bend range RPN (Registered Parameter Number) message may be generated and sent out of all the output ports. That message updates the pitch bend range on the connected musical instruments to the sum of semitones selected (2-24 corresponding to +/−2 semitones to +/−24 semitones) for the “Pitch Bend Range” and the “Global Offset Pitch Bend Range.” 24 semitones may be the maximum MIDI pitch bend range, and sending the sum allows for the above two pitch bend ranges to operate independently without bending past the maximum pitch bend range. The display 126 may be updated to display the “Global Settings and Utilities” selections menu.

When the display “Pitch Bend Tuning Mode” may be selected, the user may be prompted to select between Real-Time Tuning and Next Note Tuning. “Real-Time Tuning” means any held notes may be retuned immediately, and “Next Note Tuning” means the tuning will take effect on the next note that may be played. The display 126 may be updated to display the “Global Settings and Utilities” selections menu.

When the display “Absolute Retuning MIDI Channel” or “Relative Retuning MIDI Channel” may be selected, the user may be prompted to enter the incoming MIDI channel (0-15). If a MIDI controller sends a MIDI note on one of those channels when operating in Scala Preset mode, a tuning array or other suitable data structure may be immediately updated to use a new reference note. In some embodiments, the tuning array may be an array, or other suitable data structure, of frequencies, one for every note to be tuned. In some embodiments, the tuning array may be an array, or other suitable data structure, of numbers that correlate to frequencies in a way that may be useful for generating MIDI tuning messages such as MIDI note and pitch bend values, but not limited thereto. “Absolute” means that the new reference note may be set to the fundamental frequency of the MIDI note in the most common twelve equal divisions per octave tuning. “Relative” means that the new reference note may be set to the fundamental frequency that the MIDI note maps to applying the tuning array immediately before it may be updated. The display 126 may be updated to display the “Global Settings and Utilities” selections menu.

When the display “Pot Calibration” may be selected, the user may be instructed to turn every knob fully clockwise and then press enter. Fully clockwise produces the maximum reading of the potentiometers, and the microprocessor 150 samples the maximum readings many times to find the lowest over a short period of time. The lowest maximums may be stored in EEPROM or other memory 152 for use after powering off and on. The reason for this may be that the maximum reading may be dependent upon the power supply tolerance and thus varies by a small amount. The minimum reading may be always zero. Knowing the maximum reading may be required in order to map the readings to the full 14-bit MIDI pitch bend range. The display 126 may be updated to display the “Global Settings and Utilities” selections menu.

When the display “Mount the Micro SD Card” may be selected, the user may be instructed to insert a micro-SD card into the memory card port 136 and press enter. The micro-SD card may be then attempted to be mounted for use. The display 126 may be updated to display if there was an error or if it was mounted successfully, and then the display 126 may be updated to display the “Global Settings and Utilities” selections menu.

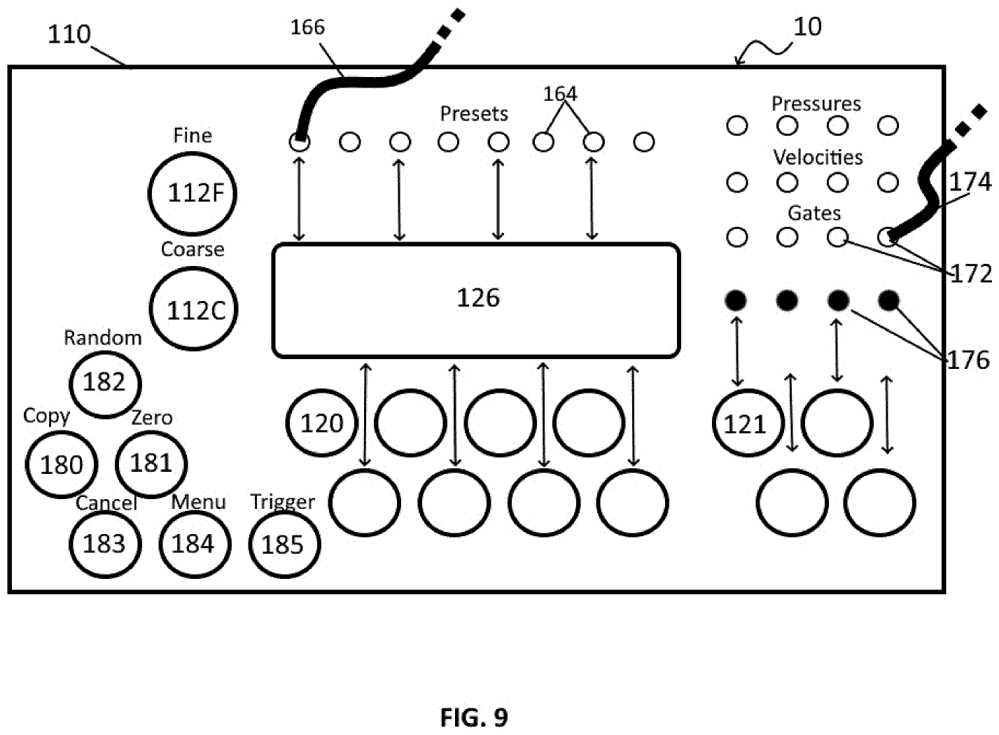

In alternative embodiments of the invention, as depicted in FIG. 9, the device 10 may be configured for permitting a musician 1 to define one or more preset values 162 corresponding to each of the elements 160 (e.g., frequency) capable of being included in a MIDI message 20, so that the preset value 162 may be applied to the input MIDI message 12 to create an output MIDI message 14. The housing 110 may define one or more preset jacks 164 for accepting a preset cable 166 therein. Each preset jack 130 may transmit an output MIDI message 14 from the device 10 to a MIDI output device 104 for creating sound or some other effect (e.g., light or motion).

In one example, a preset value 162 may be defined by the user so that when a MIDI input message 12 having a frequency element 160F1 is received, the device 10 creates an output message 14 having a different frequency element 160F2 with a different frequency (or, for example, the same frequency but a different volume/amplitude or duration or timbre). In an alternative embodiment, when a MIDI message 12 having a frequency element 160F3 is received, the device 10 creates an output message 14 having the same frequency element 160F3 and a noise distortion, light effect, or a different instrumental timber (e.g., upon receipt of a one frequency, the device 10 may cause a piano sound to be played, but the subsequent receipt of a second frequency, the device 10 may cause a trumpet sound to be played). The output message 14 may be transmitted through a preset jack 164, through a preset cable 166, to the output device 104 for producing a sound and/or effect. Using more than one preset values 162 for a single frequency, a single MIDI input message 12 may create more than one output messages 14 for transmission to the output device 104.

The user may define one or more preset values 162 using the device 10. The device 10 may include any number of buttons 117 positioned on the housing 110. Each button 117 may serve a unique function. A button 117 may be a depressible surface, a haptic surface, a switch, a sensor, or some other interface for accepting instructions from a user. Using one or more buttons 117 or potentiometers 112 the user may select, using methods described herein, a particular frequency or other element 160. Once selected, the identification of the element 160 selected may be displayed on the display 126 for verification by the user. The user may then define one or more preset values 162 to be associated with the particular element 160 selected.

The housing 110 may include one or more preset buttons 120. Each preset button 120 may correspond to one of one or more preset jacks 164. Once a particular frequency or other element 160 is selected, the user may interact with one or more of the preset buttons 120 for setting a preset value 162 for that particular element 160. The device 10 may include one or more controls 112C, 112F which may be positioned on the housing 110. The controls 112C, 112F may be any type of potentiometer or variable control device. In one embodiment, the user may, after selecting a particular frequency or element 160, depress one of the present buttons 120, and, while maintaining the depression, adjust the control(s) 112C, 112F to select a preset value 162, which may be visible on the display 126. Other embodiments using various button 117 or potentiometer 112, 114, 116 types may be envisioned. The preset value 162 may then be saved to a memory 152 of the device 10 and may correspond to that particular element 160.

The controls 112 may be two controls 112—a course control 112C for rapidly changing the preset value 162 within a preset range, and a fine control 112F for more acutely changing the preset value 162 within the range. In one example, the range for a preset value 162 for a element 160 may be between −5 Volts and +5 Volts, and the display 126 may indicate to the user a voltage up to four decimal points. The course control 112C may incrementally change the preset value 162 by 0.01 Volts and the fine control 112C may incrementally change the preset value 162 by 0.0001 Volts. In alternative embodiments, the voltage would not be displayed and instead a numerical range corresponding to the voltage may be displayed (e.g., −999 to 999 corresponding to −5V to 5V). Other ranges may be envisioned. The incremental change may also vary to provide the resolution desired.

Using the methods described herein, a user may define and store into the memory 152 of the device 10 any number of preset values 162 corresponding to one, any or all of the potential frequencies or other elements 160 containable within an input MIDI message 12. For example, a user may use the display 126 and various buttons 117 for selecting an element 160 for a preset button 120. The user may then define a certain value for the selected element 160 (e.g., a frequency of 261.63 HZ, or middle C) to be associated with the particular preset button 120. Further, the user may then define one or more preset values 162 for that preset button such that when the certain value for the selected element 160 is included in received input message 12, the device 10 alters the input message 12 by replacing certain elements 160 of the message 12 with the one or more preset values 162 stored. For example, a preset value of middle D with piano timbre may be set for any guitar elements received, or, alternatively, a preset value of middle D may be set for any middle C element received.

As MIDI messages 12 are received by the device 10, each message 12 is analyzed by the processor 150 and/or software of the device 10 for determining the various elements 160 stored within the message 12. The device 10 then applies each preset value 162 to the MIDI message 12 for creating one or more output MIDI messages 14 for transmittal to the output device 104, through the corresponding preset jack 164 and/or though the USB port 138, DIN outputs 142, 144, or another transmission method.

The output device 104 may be or include a Voltage Controlled Oscillators (VCOs), Voltage Controlled Amplifiers (VCAs), Voltage Controlled Filters (VCFs), or Envelope Generators (EGs), or sound modules or synthesizers that may permit changes in the oscillator frequency, signal amplitude, wave shape, attack time, decay time, filter cutoff, filter resonance oscillations, modulations, samples and holds, and/or noise, any of which may be included as an element 160 of the output message 14.

In addition to the ability to define one or more preset values 162 to a MIDI element 160, the user may also define one or more gates values 170 for each MIDI element 160. The device 10 may include one or more gate buttons 121. Each gate button 121 may correspond to one or more gate jacks 172. Each of the gate jacks 172 may be in communication with a corresponding input on the output device 104 through a gate cable 174. For each MIDI element 160, such as frequency, the gate value 170 may be set at 0 or 1 (corresponding, respectively to ‘off’ and ‘on’), and the user may change the gate value 170 by interacting with the gate button 121. In alternative embodiments, the gates values 170 may be automatically set to 0 or 1 and the user may manually change each gate value 170 by interacting with the corresponding gate button 121 while the device 10 is receiving and processing MIDI messages 12 in real-time. The status of the gate value 170 may be displayed on the display 126 and/or on the corresponding indicator 176.

In some instances, when setting a gate value 170 or preset value 162 for numerous elements 160, the user may interact with other buttons 117 for efficiency. In one embodiment, a copy button 180 may be positioned on the housing 100 for copying a single value 162, 170 or set of values 162, 170 from one element 160 and storing these values for another element 162.

In another embodiment, a zero button 181 may be positioned on the housing 100 for setting a single value 162, 170 or set of values 162, 170 to zero.

In another embodiment, an off button (not shown) may be positioned on the housing 100 for setting a single value 162, 170 or set of values 162, 170 to to off.

Further, a random button 182 may be positioned on the housing 100 for allowing the user to randomly generating a single value 162, 170 or set of values 162, 170.

In one embodiment, a distribute button (not shown) may be positioned on the housing for distributing a range of values. For example, in the same way that the zero button sets values to zero, the distribute button could be used to set values from 0 to 100 across a range of MIDI elements 160 (e.g., 60 set to 0, 61 set to 10, 62 set to 20, and so on).

The device 10 described herein, including the embodiment depicted in FIG. 9, permits users to have extensive creative control of the sound and experience they are creating, and in a cost-effective manner. According to devices of the prior art, users are required to use multi-tracking software and/or many synthesizers running in sync in order to create sound including diverse timbres in a single song. The device 10 described herein enables a musician with a MIDI controller 102 and this device 10 to manually create and compose songs in real-time and/or using predefined settings. For example, a musician may play a single MIDI controller 102 and trigger every MIDI input message 12 with their hands in real-time to perform a complete song composed of diverse timbres, without a backing track. Alternate scale tunings, or fully defined custom tunings, as disclosed herein could be pre-set for real-time play.

Upon receipt of a MIDI message 12, the user's predefined preset value 162 may create an altered output MIDI message 14 for initiating a specific action in a separate device 104 with which the device 10 is communicating. The output message 14 may include an element 160 having a value from a group of finite values. For example, the output message 14 may contain an element 160 having a value of zero or one for activating and deactivating a function of the separate device 104. Alternatively, the output message 14 may contain an element 160 having a value between 0 and 127 for performing up to 128 different actions through the separate device 104.

In one embodiment of the invention, the device 10 may be communicating with one or more output devices 104 being a step sequencer. The communication may occur through one or more preset cables 166 or gate cable 174 engaged with one of the preset jacks 164 or gate jacks 172, respectively. Upon receipt of an input MIDI message 12, the user's predefined preset value 162 may create an output MIDI message 14 for initiating a specific step of a sequence using the step sequencer output device 104. A step sequencer normally runs forward and loops endlessly to trigger the same sequence of steps over and over in a repetitive rhythmic pattern. If a user defines, say eight preset values 162, each corresponding to element 160 and a step in an eight-step sequence, then the user may play the steps in an arbitrary order and arbitrary rhythms using the device.

To achieve the effect of triggering different steps within a step sequencer output device 104, the device 10 may calculate the number of clock triggers needed to advance to the desired step and then transmit the clock triggers (via the output message 14) in rapid succession (e.g., less than 50 microseconds). By sending them in rapid succession, the intermediate steps never sound, and the step sequencer becomes playable with a MIDI controller 102. For example, if, say, a frequency element 160A has a preset value 162A associated with a first step of the sequencer, and frequency element 160B has a preset value 162B associated with a fifth step, then after receiving frequency element 160A in an input MIDI message 12A, and upon receipt of frequency element 160B in an input MIDI message 12B, the device 10 generates four triggers in successive output messages 14B that advance the step sequencer clock of the output device 104 to trigger the fifth step.

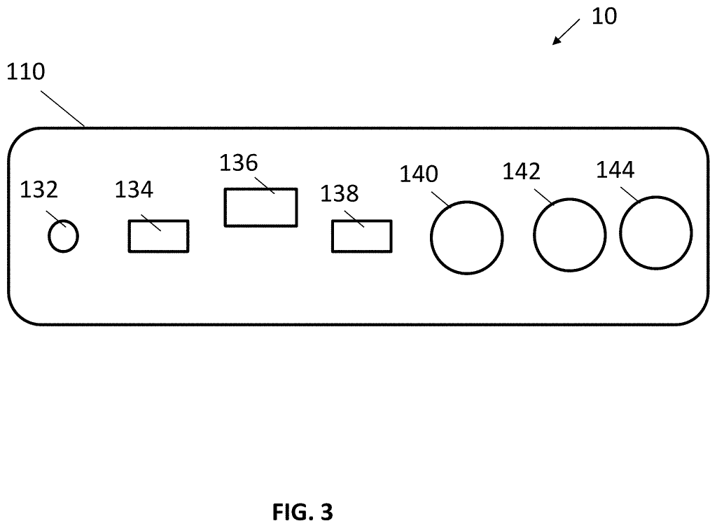

FIG. 3 may be a top view of the musical interface device 10. In some embodiments, the elements of FIG. 3 may be positioned on a side or bottom surface, or spread out amongst a top, bottom or two side surfaces. Positioned on the one more surfaces of the housing 110 or related enclosure may include a power button or switch 132 for controlling whether the device 10 receives power from a power source. The power source may deliver power to the device 10 through the USB port 134, 138 or another power port (not shown). The power button 132 may be coupled to a power supply in the housing 110 for powering the power supply on and off. The power supply in turn provides sufficient voltage, current, or the like to the various electronic components of the various embodiments of the device 10.

Further positioned on the one or more surfaces of the housing 110 may be a Universal Serial Bus (USB) device port 134, memory card such as a micro Secure Digital (SD) card port 136, USB host port 138, serial MIDI Deutsches Institut für Normung (DIN) input port 140, a serial MIDI DIN output port 142, and/or a second DIN output 144, but not limited thereto. In other embodiments, some or all of the power button 132, USB device port 134, micro SD port 136, USB host port 138, serial MIDI DIN input port 140, serial MIDI DIN output port 142, and/or second DIN output 144 may be positioned on surfaces of the housing 110 other than the top surface. In other embodiments, the device 10 may include input/output ports, connectors, or the like alternative to MIDI over DIN or USB, such as MIDI input/output over Bluetooth LE, RTP, and/or Firewire, and so on, but not limited thereto.

The USB device port 134 may be constructed and arranged to exchange data with a computer-based device, e.g., a host device, via a compatible cable or wireless connection, for example, MIDI device such as a personal computer, controller, keyboard, and so on running programs that provide various MIDI functions. A personal computer can run software that functions as a MIDI musical instrument or other MIDI device that would send and receive MIDI over the USB device port 134. In some embodiments, the USB device port 134 may be a micro-USB port or the like that in part supplies power from an external power source to a battery or power supply (not shown) in the housing 110. In some embodiments, the USB device port 134 complies with a USB specification and can include any USB connector.

The memory card port 136 may be constructed as a card slot or the like for removably receiving a micro-SD card or related computer memory card (each a memory 152) for exchanging data with the various electronic components of the musical interface device 10. The micro-SD card (not shown) when inserted in the memory card port 136 (or other memory 152) can save state information between uses, e.g., musical sessions, and load/save presents, and/or other relevant data. Such data can be stored in a known format such as a Scala file format or the like. The micro-SD card or other memory 152 may be used to store settings from session-to-session, and can save and transfer tuning preset data in a Scala format, but not limited thereto. For example, tunings created in a twelve-tone tuning mode can be saved as a preset for subsequent use and processing.

The USB host port 138 may be constructed and arranged for coupling the interface device 10 to a USB device such as a MIDI instrument or controller or related peripheral device. In some embodiments, the USB device port 134 may be coupled for sending a combination of MIDI data and audio to a computer, such as a personal computer, smartphone, tablet, Raspberry Pi, and so on. In some embodiments, a USB port 134 and/or 138 can function as either a host or a device. Additionally, the USB host port 138 can host a USB hub to host additional MIDI or related devices, up to four in some embodiments, or more in other embodiments.

The MIDI DIN input port 140 and MIDI DIN output ports 142 and 144 may be constructed and arranged to perform MIDI functions similar to the USB ports 134, 138, respectively, for example, for interfacing the interface device 10 between a keyboard controller controlling a computer and a synthesizer, drum machine, tone generator, or the like. For example, a cable can electrically couple a MIDI output connector of a keyboard to the MIDI input port 140. Another cable can electrically couple the MIDI outputs 142 or 144 to a synthesizer MIDI input. In some embodiments, MIDI input, e.g., incoming MIDI messages 12 from a MIDI controller or the like, may be via the IN DIN connector 140, the micro USB port 134, or the USB host port 138, and MIDI output messages 14 can be configured to route or otherwise be output from the DIN output ports 142 and 144, the micro USB port 134, or the USB host port 138 for use with a personal computer or other MIDI instrument.

Generally, as described above, the device 10 may be configured for receiving input MIDI messages 12 from one or more MIDI controllers 102 through a cable, wirelessly or through some other electronic or transmittable communication. The MIDI messages 12 may be received through alternative MIDI connection schemes, MIDI 2.0, etc.

The various potentiometers, knobs, ports, buttons, etc. may be physical elements that can be rotated, pressed, or electrically coupled. In other embodiments, instead of physical potentiometers, knobs, buttons, and so on, some or all of these elements may be icons, graphical display elements or the like that may be electronically displayed on a graphical user interface of a computer display and activated by a mouse, finger, stylus, speech command or other computer-based input. In doing so, the microprocessor 150 and/or other circuits in the housing 110 receive data signals from the user interface to perform comparable functions as the physical potentiometers, knobs, ports, buttons, etc. In some embodiments, a graphical user interface displaying the potentiometers, knobs, ports, buttons, etc. as icons or other graphical elements communicates with the microprocessor 150 of a musical device 10, but without some or all of the various potentiometers, displays, knobs, etc. as shown in the Figures.

FIG. 4 may be a block diagram of the musical interface device 10 of FIGS. 2 and 3. In particular, the microprocessor 150 may include inputs and outputs via electronic connection devices to each of the MIDI I/O components via USB and DIN connectors 134-142, micro-SD card slot 136, rotary enclosure 118, buttons 122, 124, potentiometers 112, display 126, and analog-to-digital converter (ADC) 130. The microprocessor 150 may execute computer instructions that permit the musical interface device 10 to perform tuning operations according to embodiments, for example, described herein. In some embodiments, the microprocessor 150 includes an off-the-shelf computer for performing special-purpose functions regarding the operation of the interface device 10, for example, a 180 MHz ARM Cortex-M4 microprocessor, but not limited thereto. In some embodiments, the micro-SD card slot 136, USB device connection 134 and USB host connection 138 may be coupled to a Teensy 3.6 development board or the like of the microprocessor 150.

A state of the potentiometers 112, 114, 116 may be read by the microprocessors via at least one ADC 130, for example, two 8-channel ADCs. Here, the potentiometers 112, 114, 116 may be configured as voltage dividers and present voltages (for example, respectively, to 14 of the 16 ADC channels and the remaining 2 ADC channels may be ignored, or not used). The ADCs 130 may digitize the voltages for processing by the microprocessor 150. In some embodiments, the ADC 130 operates at 500K samples per second. In some embodiments, each ADC 130 may provide 10 to 16-bit resolution, or greater. The higher resolution, for example, 16-bit, may provide for smoother tuning across larger frequency ranges, and may also accommodate for MIDI messages used for tuning which use 14-bit values or more. In some embodiments, the display 126 communicates with the microprocessor 150 via a shift register, for example, an 8-bit, serial-in, parallel-out shift register or the like. In some embodiments, one or more shift registers between the microprocessor 150 and display 126 operates at 3.3V levels at its inputs, and 5V at its outputs, and bridges these two voltage levels for use by the display 126, but not limited thereto.

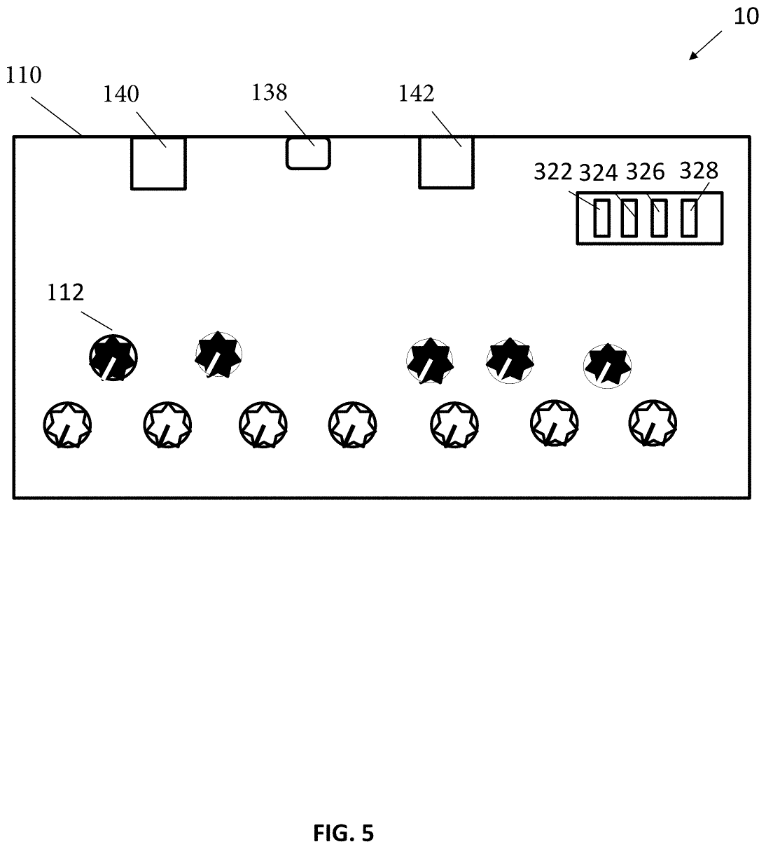

FIG. 5 may be a front view of a musical interface device 10, in accordance with other embodiments of the inventive concepts. The musical interface device 10 performs similar functions as the musical interface 10 of FIGS. 2-4, except for a different arrangement of potentiometers 112, 114, 116, buttons 117, and other elements arranged on the housing 110 of the interface device 10. As with the interface device 10 of FIGS. 2-4, the construction, layout, and configuration may be provided to simplify fine tuning control for a user.

The musical interface device 10 may include an IN DIN connector 140, e.g., a standard 5-pin MIDI input, an OUT DIN connector 142, e.g., a standard 5-pin MIDI output and a micro-USB port 138. In some embodiments, the MIDI IN DIN 140 connects a serial input pin on the microprocessor 150 via an optocoupler, which can electrically isolate the MIDI input messages 12 from the rest of the circuit to prevent ground loops or the like. A MIDI output 14 may be user-selectable or automatically selectable by a computer or other electronic switch for output to one or more output devices 104 from one of the OUT DIN connector 142 and/or a USB port 138. The output DIN connector 142 can be constructed and arranged to output “tuned” MIDI data to a MIDI output device 104 over a standard MIDI cable, and can connect to a serial output pin on the microprocessor 150. In some embodiments, the USB port 138 can be used to input/output MIDI data. In some embodiments, the USB port 138 process a supply power from a power source, for example, to power the interface device 10.

As shown in FIG. 5, a plurality of two-way switches 322, 324, 326, 328 may be selectable between the four following mode options. In FIG. 2, a combination of buttons 118, 122, rotary encoder knob 124, and display 126 may be used instead of physical switch elements for mode selection.

Switch 322 can be selectable between a polyphonic MIDI instrument or a monophonic MIDI instrument. In particular, when the polyphonic (POLY) mode may be selected, MIDI data may be output to a polyphonic MIDI device 104. When a monophonic (MONO) mode may be selected, MIDI data may be output to a monophonic device 104. The main difference may be that the monophonic (MONO) mode attempts to retrigger the last note played if more than one key may be held down, as may be a commonly used keyboard technique in monophonic synthesizer playing.

Switch 324 may be selectable, e.g., toggle, between output via the USB port 138 and DIN output(s) 142, 144. In particular, when the USB output is selected, output MIDI messages 14 may be sent from the USB port 138. When the DIN output(s) are selected, output MIDI messages 14 may be sent on a standard 5-pin MIDI DIN connection 142 or the like.

Switch 326 may allow a user to toggle between a pitch blend (PB) or MIDI Tuning Standard (MTS) mode either of which can implement a basic scale mode such as a twelve-tone scale mode or Equal Divisions per Octave (EDO) mode, depending on the type of musical instrument and/or synthesizer supporting MIDI control messages complying with PB and/or MTS mode. The MIDI pitch bend mode may be backwards compatible and designed to work with all MIDI synthesizers. Whereas the MIDI Tuning Standard may be a more flexible method for tuning microtonally with MIDI but currently only supported by a limited number of modern synthesizers. Switch 328 allows a user to toggle between different basic scale modes such as a twelve-tone scale and EDO modes. Here, when twelve-tone scale mode may be selected, all potentiometers 112 may operate to tune twelve notes per octave. When EDO mode may be selected, only the G♯ and A♯ knobs/potentiometers 112 may be used to select an n equal divisions per octave scale, where n may be between 5 and 53, tuned to a MIDI root note between having a range of 0-127.

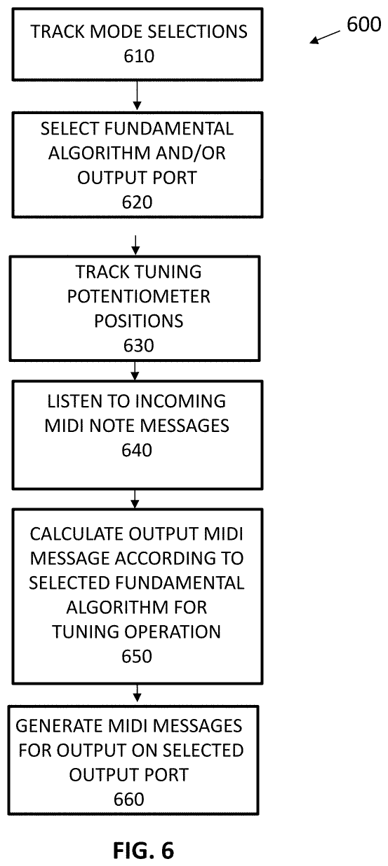

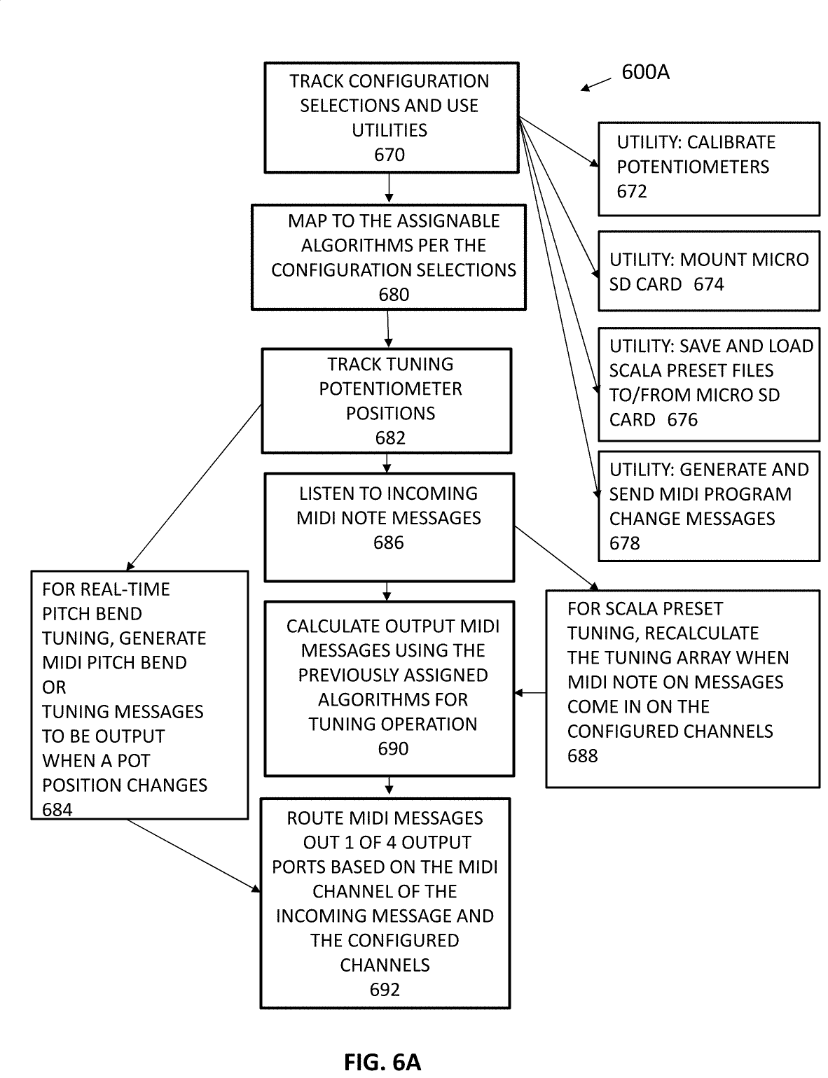

FIG. 6 is a flow diagram of a method 600 of operation of a musical device 10, in accordance with some embodiments of the inventive concepts. Some or all of the method 600 can be performed in the musical interface device 10 of FIGS. 1-4 or FIG. 5.

At block 610, mode selections of the mode switches 322, 324, 326, 328 of FIG. 5 or buttons 118, 122 and rotary encoder 124 of FIG. 2 may be tracked, for example, used to navigate the menu system to change settings and use utilities, described herein with respect to the configuration menu tree.

At block 620, a fundamental algorithm and/or output port may be selected that corresponds to the mode selection of block 610. The fundamental algorithm and/or output port can be selected according to the arrangement of 322, 324, 326, 328 of FIG. 4 or buttons 118, 122 and rotary encoder 124 of FIG. 2. The selected fundamental algorithm, also referred to herein as an assignable algorithm, calculates the outbound MIDI messages 14 that perform the tuning when output from the interface device 10 to an output device 104 or the like, which plays the microtuned pitches produced by the interface device 10. In some embodiments, a fundamental algorithm can be one of a monophonic twelve-tone using MIDI PB, polyphonic twelve-tone using MIDI PB, monophonic EDO using MIDI PB, polyphonic EDO using MIDI pitch bend, twelve-tone using MTS, or EDO using MTS, Scala preset, number of MIDI channels, monophonic note retrigger priority, real-time pitch bend tuning, and/or next note pitch bend tuning, but not limited thereto. In one embodiment, some or all of these fundamental algorithms may be implemented by incorporating some or all of the computing elements of the interface device 10 described herein, for example, stored in a computer memory 152 and executed by a hardware processor of the interface device 10.

At block 630, the positions of the tuning potentiometers 112 may be detected, captured, and stored.

At block 640, the musical device 10 electronically listens for incoming MIDI note messages 12 from the IN DIN connector 140 or a micro-USB port 134.

At block 650, a calculation may be performed on an incoming MIDI note message 12 using the positions of the tuning potentiometers 112 or the preset values 162 and the selected fundamental algorithm.

At block 660, a generated result of the calculation results in one or more MIDI messages 14 that may be subsequently output via a selected output port, for example, in response to a USB vs. DIN mode select switch 324 of FIG. 5 or a combination of buttons 118, 122 and display 126 shown in FIG. 2, or automatically determined by a special-purpose processor of the interface device 10.

FIG. 6A is a flow diagram of a method 600A of operation of a musical device 10, in accordance with some embodiments of the inventive concepts. Some or all of the method 600A may include elements of the method 600 of FIG. 6 as well as additional steps.

At block 670, the musical interface device 10 includes detection devices, computer processors, and the like for listening for changes to the state of the buttons 118, 122 and the rotary encoder 124. Those states may be used to navigate the menu tree displayed on the display 126 to make configuration selections and use utilities.

At block 672, the potentiometers 112, 114, 116 may be calibrated. The user may be instructed to turn every knob fully clockwise and press the Enter button 122 that produces the maximum reading for each potentiometer in this embodiment. The maximum reading can vary between physical units because it depends on the power supply's actual voltage which may be within a certain range of the nominal voltage. Each potentiometer may be sampled 1,000 times, but not limited thereto so another sampling value may be used, and the lowest maximum reading for each may be saved in the EEPROM (non-volatile memory) on board the microprocessor 150, or other memory 152. The maximum readings may be used in calculations so that the entire physical range of each potentiometer may be mapped exactly to the 14-bit number range (0-16383) that may be ideal for MIDI pitch bend and MIDI tuning standard messages.

At block 674, a micro-SD card or other memory 152 may be mounted after the interface device may be powered on. The user may be instructed to insert a micro-SD card or enable other memory 152 and press the Enter button 122. Any error encountered or a successful mount may be displayed on the display 126.

At block 676, Scala preset files may be saved to a micro-SD card or other memory 152 in twelve tone tuning mode, and Scala preset files can be loaded from a micro-SD card or other memory 152 in Scala preset tuning mode.

At block 678, the user may select the output port and MIDI values required: MSB (Most Significant Byte), LSB (Least Significant Byte), and the Program number, and MIDI program change messages for multiple channels can be efficiently sent out to change the program for a connected musical output device 104 and/or input device 102.

At block 680, the fundamental algorithms that corresponds to the configuration selections of block 670 may be mapped for use. The fundamental algorithms calculate in real-time the outbound MIDI messages 14 that perform the tuning when output from the interface device 10 to an output device 104 or the like, which plays the microtuned pitches produced by the interface device 10.

In some embodiments, each of the four MIDI output ports 134, 138, 142, 144 has an identical set of fundamental algorithms, and performs the following functions: 1) handle incoming MIDI note on messages, 2) handle incoming MIDI note off messages, 3) handle incoming MIDI pitch bend messages, 4) do real-time tuning versus do next note tuning, 5) handle MIDI messages other than note on, note off, and pitch bend. In order to minimize the processing time and keep the overall controller-to-instrument latency low, the algorithms may be highly specific and assigned prior to when incoming MIDI 12 may be to be processed.

The fundamental algorithms may be mapped based on the following configuration selections: twelve-tone tuning versus Scala preset tuning, MIDI pitch bend versus MIDI tuning standard, number of output MIDI channels to use, MIDI tuning standard format with a bank versus without a bank, low note versus high note versus last note monophonic retrigger, pitch bend tuning real-time tuning versus next note tuning.

The fundamental algorithms to handle incoming MIDI note on messages 12 may be one or more of the following: twelve tone tuning with pitch bend mode for at least twelve MIDI channels, twelve tone tuning for pitch bend mode for less than twelve MIDI channels but more than one, twelve tone tuning for pitch bend mode with only one MIDI channel, Scala preset tuning with pitch bend for more than one MIDI channel, Scala preset tuning with pitch bend for only one MIDI channel, twelve tone tuning with MIDI tuning standard without a specified bank, twelve tone tuning with MIDI tuning standard with a bank, Scala preset tuning with MIDI tuning standard without a specified bank, Scala preset tuning with MIDI tuning standard with a bank. All of the above algorithms generate for output a MIDI note on message. The above algorithms that do “twelve tone tuning” calculate a MIDI pitch bend or tuning value based on the 14-bit values corresponding to the positions of the potentiometers 112, 114, 116. The above algorithms that do “Scala preset tuning” calculate a MIDI pitch bend or tuning value based on values stored in a lookup array that may be generated when a new Scala preset file may be loaded and whenever the reference tuning note may be updated. The above algorithms designated for use “with pitch bend” track the MIDI channel(s) of the note on message(s) so they can later be turned off.

The fundamental algorithms to handle incoming MIDI note off messages may be one or more of the following: twelve tone tuning with pitch bend mode for at least twelve MIDI channels, twelve tone tuning for pitch bend mode for less than twelve MIDI channels but more than one, twelve tone tuning for pitch bend mode with only one MIDI channel and low note retrigger, twelve tone tuning for pitch bend mode with only one MIDI channel and high note retrigger, twelve tone tuning for pitch bend mode with only one MIDI channel and last note retrigger, Scala preset tuning with pitch bend for more than one MIDI channel, Scala preset tuning with pitch bend for only one MIDI channel and low note retrigger, Scala preset tuning with pitch bend for only one MIDI channel and high note retrigger, Scala preset tuning with pitch bend for only one MIDI channel and last note retrigger, twelve tone tuning with MIDI tuning standard without a specified bank, twelve tone tuning with MIDI tuning standard with a bank, Scala preset tuning with MIDI tuning standard without a specified bank, Scala preset tuning with MIDI tuning standard with a bank. All of the above algorithms generate for output a MIDI note off message. The above algorithms that may be “for only one MIDI channel” have an additional step to retrigger any held notes, as this may be a common technique used when playing a monophonic musical instrument. The above algorithms designated for use “with pitch bend” use the MIDI channel that was tracked in the assigned MIDI note on algorithm.

The fundamental algorithms to handle incoming MIDI pitch bend messages may be one or more of the following: tuning with MIDI pitch bend, tuning with MIDI tuning standard. The former algorithm ignores and discards any incoming MIDI pitch bend messages since pitch bend may be output to perform the tuning. The latter algorithm simply passes the incoming MIDI pitch bend messages through to the output.

The fundamental algorithms to handle MIDI messages other than note on, note off, and pitch bend may be one or more of the following: tuning with MIDI pitch bend, tuning with MIDI tuning standard. The former algorithm passes through any incoming MIDI messages to output on all MIDI channels being used. The latter algorithm passes through any incoming MIDI messages to output on the single MIDI channel that may be used.

The fundamental algorithms to handle doing real-time tuning versus next note tuning may be one or more of: tuning in real-time with pitch bend, tuning in real-time with MIDI tuning standard, tuning on the next note. The first algorithm generates for output MIDI pitch bend messages as tuning changes in real time. The second algorithm generates for output MIDI tuning standard messages as tuning change in real time. The last algorithm simply ignores any tuning changes and lets it happen when the next MIDI note on assigned algorithm may be called.

At block 682, the positions of the tuning potentiometers 112, 114, 116 and/or valued of the preset values 162 may be detected, captured, and stored.

At block 684, when real-time pitch bend tuning may be selected in the configuration at block 610, MIDI pitch bend or MIDI tuning standard messages may be generated for output whenever a potentiometer position changes.

At block 686, the musical interface device 10 may listen for incoming MIDI note messages from the IN DIN connector 140, the micro-USB port 134, and/or the USB host port 138.

At block 688, when Scala preset tuning may be selected in the configuration and when an incoming MIDI note 12 on message's channel matches the one configured for absolute retuning or the one configured for relative retuning, then the tuning array used in block 650 for Scala preset tuning calculations may be updated accordingly. In some embodiments, absolute and relative retuning in a Scala Preset mode where the tuning array may be updated in real-time relative to an incoming MIDI note 12, possibly while using a second MIDI controller in parallel. In some embodiments, one or more dedicated hardware ports for incoming MIDI may be used to receive MIDI note on messages intended to be used for absolute or relative retuning, in which case the MIDI channel could be any valid MIDI channel. In some embodiments, one or more buttons, a rotary encoder, a potentiometer, or the like may be used to select a reference note or reference frequency used to calculate the values stored in the tuning array.

At block 690, a calculation may be performed in real-time on incoming MIDI messages 12 using the positions of the tuning potentiometers 112, 114, 116 and the previously assigned fundamental algorithms. If the message may be a note on, then the preassigned fundamental algorithm to handle note on messages may be executed. If the message is a note off, then the preassigned fundamental algorithm to handle note off messages may be executed. If the message is a pitch bend, then the preassigned fundamental algorithms to handle pitch bend messages may be executed; also the preassigned fundamental algorithm to handle real-time tuning versus next note tuning may be executed. If the message is another type of MIDI message, then the preassigned fundamental algorithm for other MIDI messages may be executed. All of the preassigned fundamental algorithms result in either ignoring/discarding the MIDI or generating MIDI tuning messages 14 to be sent out of one of the four output ports to a device 104.

At block 692, a generated result of the calculation results in one or more MIDI messages that may be subsequently output via one of the four output ports: the micro-USB port 134, USB host port 138, output DIN1 connector 140, or output DIN2 connector 144. Each output port may be configured in block 670 to have a unique input MIDI channel that determines which output port may be used for any resulting MIDI messages that may be generated for output.

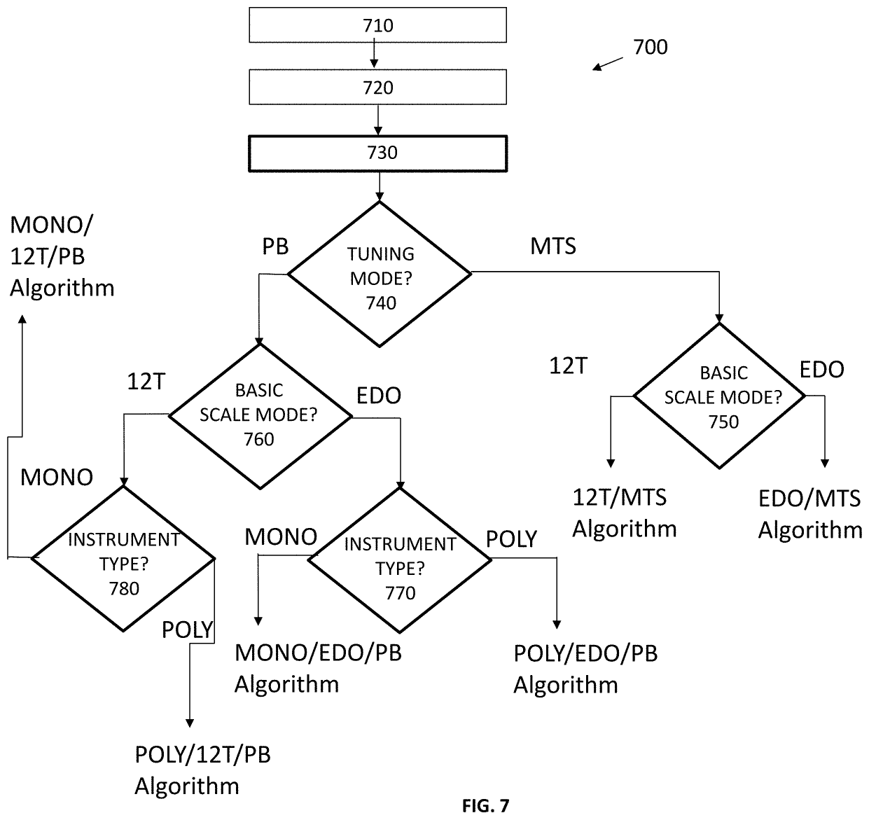

FIG. 7 is a flow diagram of a method 700 for processing MIDI messages, in accordance with some embodiments of the inventive concepts. Some or all of the method 700 can be performed in the musical interface device 10.

At block 710, the positions of the tuning potentiometers 112 and/or the values of the preset values may be tracked, similar to step 630 of FIG. 6. For example, the knob/potentiometer positions may be tracked, for example, by the microprocessor 150 and matched to corresponding 14-bit (per the MIDI specification) numerical tuning values. In some embodiments, the ADCs 130 read voltages (0 to +5V nominal) that corresponds to the potentiometer positions 112, 114, 116 (fully counterclockwise to fully clockwise) and linearly map them to 16-bit numbers (0-65535). Those numbers may be sent to the microprocessor 150 when it requests them, and it then maps them to 14-bit numbers (0-16383) as may be required by the MIDI pitch bend and MIDI tuning standard specifications.

At block 720, data corresponding to the tracked potentiometer positions and/or preset values 162 may be stored, for example, in a database, computer memory, or other electronic data storage device.

At block 730, the musical interface device 10 listens for incoming MIDI note messages from the IN DIN connector 140 or micro-USB port 134.

At decision diamond 740, a determination may be made whether a selected tuning mode may be a PB mode or an MTS mode. If an EDO mode may be selected, then the method 700 proceeds to decision diamond 750, wherein a determination may be made whether a selected basic scale mode may be an EDO mode or a twelve-tone (12T) mode. If at decision diamond 750 the basic scale mode may be an EDO mode, then a fundamental algorithm may be executed for performing calculations resulting in MIDI messages output from the selected output port in compliance with EDO using MTS.

If at decision diamond 750, the selected basic scale mode may be determined to be a 12T mode, then a fundamental algorithm may be executed for performing calculations resulting in MIDI messages output from the selected output port in compliance with 12T using MTS.

Returning to decision diamond 740, if a PB mode may be selected, then the method 700 proceeds to decision diamond 760, wherein a determination may be made whether a basic scale mode may be an EDO mode or a twelve-tone (12T) mode. If at decision diamond 760 the basic scale mode may be an EDO mode, then the method 700 proceeds to decision diamond 770, where a determination may be made whether a selected instrument type may be a polyphonic (POLY) MIDI instrument or a monophonic (MONO) MIDI instrument. If at decision diamond 770 the instrument type may be determined to be a polyphonic (POLY) MIDI instrument, then a fundamental algorithm may be executed for performing calculations resulting in MIDI messages output from the selected output port in compliance with polyphonic EDO using a MIDI pitch bend. Otherwise, a fundamental algorithm may be executed for performing calculations resulting in MIDI messages output from the selected output port in compliance with monophonic EDO using a MIDI pitch bend.

Returning to decision diamond 760, if the basic scale mode may be determined to be a twelve-tone (12T) mode, then the method 700 proceeds to decision diamond 780, where a determination may be made that the basic scale mode may be a twelve-tone mode. Here, the method 700 proceeds to decision diamond 780 where a determination may be made whether a selected instrument type may be a polyphonic (POLY) MIDI instrument or a monophonic (MONO) MIDI instrument. If at decision diamond 780 the instrument type may be determined to be a polyphonic (POLY) MIDI instrument, then a fundamental algorithm may be executed for performing calculations resulting in MIDI messages output from the selected output port in compliance with polyphonic 12T using a MIDI pitch bend. Otherwise, a fundamental algorithm may be executed for performing calculations resulting in MIDI messages output from the selected output port in compliance with monophonic 12T using a MIDI pitch bend. Upon receiving incoming MIDI note messages, the interface device 10 executes exactly 1 of the 6 fundamental algorithms to calculate the appropriate MIDI messages for output.

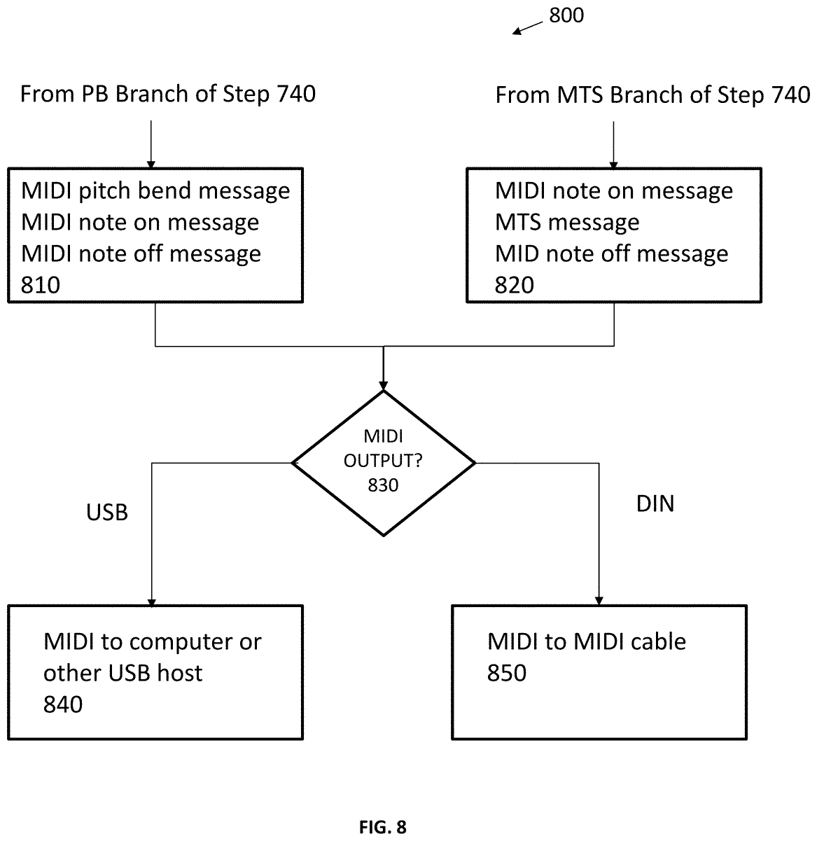

FIG. 8 may be a flow diagram of a method 800 for processing MIDI messages, in accordance with some embodiments of the inventive concepts. Some or all of the method 800 can be performed in the musical interface device 10.

As previously described, during operation, the interface device 10 listens for MIDI note messages 12 on an incoming MIDI stream. The potentiometer positions 112, 114, 116 may be kept track of and matched to corresponding 14-bit (per the MIDI specification) numerical tuning values. When a note message may be received, the interface device 10 generates an outgoing MIDI message 14 that retunes that note according to how the potentiometers 112, 114, 116 may be set.

For example, referring again to block 740 of FIG. 7, the pitch blend (PB) branch may include a MIDI pitch blend message, a MIDI note on message, and/or a MIDI note off message. In embodiments where at least one of the monophonic twelve notes per octave MIDI pitch bend mode (MONO/12T/PB), polyphonic twelve notes per octave MIDI pitch bend mode (POLY/12T/PB), monophonic n-equal divisions per octave MIDI pitch bend mode (MONO/EDO/PB), or polyphonic n-equal divisions per octave MIDI pitch bend mode (POLY/EDO/PB) fundamental algorithms may be executed, at block 810, a MIDI “pitch bend” message may be sent immediately followed by a MIDI “note on” message. This results in the pitch being “bent” and held before the note sounds on the MIDI output device 104. Every MIDI “note on” message received may be translated in real time to an outgoing MIDI “pitch bend” and “note on” pair.

A major complication may be that certain versions of the MIDI protocol, in particular, versions prior to v2.0, “pitch bend” messages may be channel-wide messages (in MIDI v1.0, the current version used in commercial products). Usually only a single channel of MIDI may be used at a time, so then pitch bend affects all the notes sounding. In the case of MONO/12T/TB, POLY/12T/PB, MONO/EDO/PB, POLY/EDO/PB fundamental algorithms, in addition to “retuning the MIDI stream,” the algorithms also juggle the notes that may be being held on by distributing them over the 16 available MIDI channels. For example, playing a C-major triad thru the musical device 10 results in the 3 MIDI “pitch bend” and “note on” pairs being played over 3 different MIDI channels so that each of the 3 notes can have their own independent pitch bend. In MIDI v2.0, pitch bend messages can be generated on a per note basis, so using multiple channels may be not necessary, which can simplify the microtuning algorithms. Accordingly, the interface device 10 can operate according to the MIDI v2.0 specification, or related operating protocols such as OSC, but not limited thereto.

For a monophonic twelve notes per octave MIDI pitch bend mode (MONO/12T/PB) algorithm, the device listens for all incoming MIDI notes and outputs corresponding MIDI notes and pitch bends on the first channel. All 12 tuning potentiometers may be used to calculate the MIDI pitch bend and note. The MIDI pitch bend may be output followed by the MIDI note on. A MIDI note off may be sent when various notes may be turned off. Only one pitch bend value per live MIDI channel may be output. The last note may be retriggered if more than one note may be held when another may be released.

The POLY/12T/PB algorithm may be similar to the MONO/12T/PB algorithm, except that there may be no retrigger step.

The MONO/EDO/PB algorithm may be similar to the MONO/12T/PB algorithm except that only the G♯/Ab and A♯/Bb potentiometers may be used, in some embodiments, to calculate the MIDI pitch bend and note. This results in 49 EDO scales between 5-EDO and 53-EDO, tuned to a root note between 0-127. The POLY/EDO/PB algorithm may be similar to the MONO/EDO/PB algorithm, except that there may be no retrigger step.

Referring again to block 740 of FIG. 7 as well as block 820 of FIG. 8, the MIDI Tuning Standard (MTS) mode branch may include a MIDI note on message, MTS message, and/or a MIDI note off message.

The 12T/MTS algorithm includes the passing of MIDI note messages in an untouched manner. MTS messages may be sent if any one or more of the twelve potentiometers have changed since a previous operation. The EDO/MTS algorithm may be similar except only the G♯/Ab and A♯/Bb potentiometers may be used.

For the 12T/MTS and EDO/MTS fundamental algorithms, an MTS message may be output according to the positions of the knobs/potentiometers and may be independent of the MIDI stream incoming to the interface device 10. MTS messages modify the tuning table internal to a MIDI output device 104 so that the device 104 itself plays a microtonal scale without using MIDI “pitch bend” messages. In this case, it may be optional that the MIDI controller 102 send messages into the interface device 10. The MTS messages may be generated by knob movements on the interface device 10, and they may be sent out to the MIDI output device 104.

At decision diamond 830, a determination may be made whether the MIDI messages 14 may be sent to the output device 104 via a DIN output port 142 in FIG. 3, e.g., a standard 5-pin MIDI cable or a USB output port.

Some or all of the foregoing can be deployed in a computer system that may be included in an apparatus of FIGS. 1-5 and 9 and the methods illustrated in FIGS. 6-8 in accordance with the embodiments of the present disclosure. The computer system may generally comprise a processor, an input device coupled to the processor, an output device coupled to the processor, and at least one memory device coupled to the processor via a bus. The bus may provide a communication link between each of the components in computer, and may include any type of transmission link, including electrical, optical, wireless, etc. The processor may perform computations and control the functions of a computer, including executing instructions included in the computer code for the tools and programs capable of implementing a method, in the manner prescribed by one or more elements of the system and methods described in embodiments herein, wherein the instructions of the computer code may be executed by processor via a computer memory device. The computer code may include software or program instructions that may implement one or more algorithms for implementing the methods of providing a result, as described in detail above. The processor executes the computer code.

In some embodiments, the device 10 may include a second thru or a wireless transmitter for electronically communicating with a computing device. The device 10 may communicate any or all of the information stored in memory 152 to the computing device, and further be configured for receiving any information from the computing device. In such embodiments, multiple devices 10 may backup and/or share preset values 152 or any other information stored in memory 152. The computing device may include software for viewing and/or modifying the information, once received.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

As shown above and as will be appreciated by one skilled in the art, aspects of the present invention may take the form of an entirely hardware embodiment, but are not limited thereto. For example, aspects may take the form of a special-purpose computer that includes an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Therefore, in some embodiments, the musical device's functionality may be implemented in software with virtual sliders. In some embodiments, the systems and methods herein include a musical apparatus tuning scheme that could be implemented without using MIDI. For example, hardware and/or software may be implemented as part of a keyboard synthesizer, for instance, where the tuning may be performed internally without the need for MIDI.

Although the invention may be described herein with reference to specific embodiments, various modifications and changes can be made without departing from the scope of the present invention as set forth in the claims below. Accordingly, the specification and figures may be to be regarded in an illustrative rather than a restrictive sense, and all such modifications may be intended to be included within the scope of the present invention. Any benefits, advantages, or solutions to problems that may be described herein with regard to specific embodiments may be not intended to be construed as a critical, required, or essential feature or element of any or all the claims.

Unless stated otherwise, terms such as “first” and “second” may be used to arbitrarily distinguish between the elements such terms describe. Thus, these terms are not necessarily intended to indicate temporal or other prioritization of such elements.

What is claimed is:

1. A method for a musical device for modifying a MIDI input to create a MIDI output, comprising:
selecting a MIDI input element and an input value for the MIDI input element by interacting with the musical device;
defining a preset value corresponding to the input value by further interacting with the musical device, wherein the preset value includes an output value for an output element;
the musical device receiving the input value for the MIDI input element in an input MIDI message;
the musical device modifying the MIDI input message to include the output value for the output element, thereby creating the at least one MIDI output;
the musical device transmitting the MIDI output.

2. The method of claim 1, wherein the input element is frequency.

3. The method of claim 2, wherein the output element is frequency and the output value is not equal to the first value.

4. The method of claim 2, wherein the output element is timbre.

5. The method of claim 1, wherein the selecting an input element includes interacting with at least one button and at least one potentiometer of the musical device.

6. The method of claim 1, wherein the transmitting the MIDI output occurs using a preset jack of the musical device, the preset jack being in communication with an output device.

7. The method of claim 1, further comprising display the input element, the input value, the output value and/or the output element on a display positioned on the musical device.

8. The method of claim 1, further comprising storing the input element, the input value, the output value and/or the output element in memory of the musical device.

9. The method of claim 8, further comprising storing at least a portion of the memory on a USB device engaged with a USB port positioned on the musical device.

10. The method of claim 1, further comprising:
selecting a second MIDI input element and a second input value for the second MIDI input element by interacting with the musical device;
defining a second preset value corresponding to the second input value by further interacting with the musical device, wherein the second preset value includes a second output value for a second output element;
the musical device receiving the second input value for the second MIDI input element in the input MIDI message;
the musical device modifying the MIDI input message to include the second output value for the second output element, thereby creating a second MIDI output;
the musical device transmitting the second MIDI output.
